(19) United States
(12) Patent Application Publication
(10) Pub. No.: US 2012/0086347 A1
(43) Pub. Date: Apr. 12, 2012

(54) CONTROL CIRCUIT OF LIGHT EMITTING DIODES

(76) Inventors: Ching-Tsan Lee, Hsin-Chu (TW); Pai-Feng Liu, Hsin-Chu (TW)

(21) Appl. No.: 13/267,906

(22) Filed: Oct. 7, 2011

(30) Foreign Application Priority Data
Oct. 7, 2010 (TW) 099134174

(51) Int. Cl. H05B 37/02

(52) U.S. Cl. 315/185 R

(57) ABSTRACT

A control circuit of light emitting diodes includes a driver and a target voltage adjuster. The driver is used for providing an output power to drive at least one series of light emitting diodes, and the driver forces a smallest terminal voltage on the terminals of the at least one series of light emitting diodes to approach a target voltage. The target voltage adjuster adjusts the target voltage according to the smallest terminal voltage.

### BACKGROUND OF THE INVENTION

1. Field of the Invention

The present invention is related to a control circuit of light emitting diodes, and particularly to a control circuit of light emitting diodes that can shift noise caused by a low frequency dimming signal.

2. Description of the Prior Art

A plurality of series of light emitting diodes can act as backlight of a liquid crystal display. When the plurality of series of light emitting diodes are driven, a conventional driving circuit can be considered a two-stage circuit. A first stage circuit of the two-stage circuit is a voltage regulator which sinks power from a main power supply (such as an AC power or a DC power) to provide a stable output voltage. For example, the first stage circuit is an inductor-inductor-capacitor (LLC) power circuit or a quasi-resonant power circuit. A second stage circuit is a current balancing circuit for providing a plurality of roughly equal constant currents to drive the plurality of series of light emitting diodes. For example, in FIG. 1, a quasi-resonant power circuit 10 acts as a first stage circuit for receiving an alternating current voltage V_{AC} from AC power. A bridge rectifier 32 rectifies the alternating current voltage V_{AC} to a rough direct current voltage V_{IN}. A transformer 20 has a primary winding 24, a secondary winding 22, and an auxiliary winding 25 for storing and releasing power of the AC power. A quasi-resonant controller 18 controls a power switch 15. Power released by the secondary winding 22 can set an output voltage V_{OUT} through an output capacitor 13. The output voltage V_{OUT} can be controlled through a feedback loop composed of a voltage divider 12, an LT431, a photo coupler 14, and the quasi-resonant controller 18. Further, operational principles of the quasi-resonant power circuit 10 are known by those skilled in the prior art, so further description thereof is omitted for simplicity. As shown in FIG. 1, a current balancing circuit 30 provides each series of light emitting diodes with a corresponding current source, so current flowing through each series of light emitting diodes is roughly the same. In FIG. 1, the current balancing circuit 30 only provides two series of light emitting diodes with corresponding current sources, but number of series of light emitting diodes is determined by a system in practice. A dimming signal VDIM controls the current balancing circuit 30 through a DIM terminal. In general, the dimming signal VDIM controls luminance of each series of light emitting diodes through changing a duty cycle of a corresponding current source.

However, when a user utilizes the dimming signal VDIM to dim luminance of each series of light emitting diodes, a resonance of an operational frequency of the quasi-resonant power circuit 10 may enter the range of human hearing and generate noise because of a corresponding current source toggling between a heavy load and a light load.

### SUMMARY OF THE INVENTION

An embodiment provides a control circuit of light emitting diodes. The control circuit includes a driver and a target voltage adjuster. The driver is used for providing an output power to drive at least one series of light emitting diodes, and the driver forces a smallest terminal voltage on the terminals of the at least one series of light emitting diodes to approach a target voltage. The target voltage adjuster is used for adjusting the target voltage according to the smallest terminal voltage.

Another embodiment provides a control circuit of light emitting diodes for driving at least one series of light emitting diodes, where the at least one series of light emitting diodes is coupled to an output power. The control circuit includes a smallest voltage feedback circuit and a target voltage adjuster. The smallest voltage feedback circuit is used for generating an adjusting signal according to a smallest terminal voltage of the at least one series of light emitting diodes and a target voltage, wherein the adjusting signal influences the output power and forces the smallest terminal voltage to approach the target voltage. The target voltage adjuster is used for adjusting the target voltage according to the smallest terminal voltage.

The present invention provides a control circuit of light emitting diodes. The control circuit can limit noise caused by round-trip time to 60 Hz or lower than 60 Hz, which is out of the range of human hearing by a mechanism through adjusting a target voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a quasi-resonant power circuit for driving light emitting diodes according to the prior art.

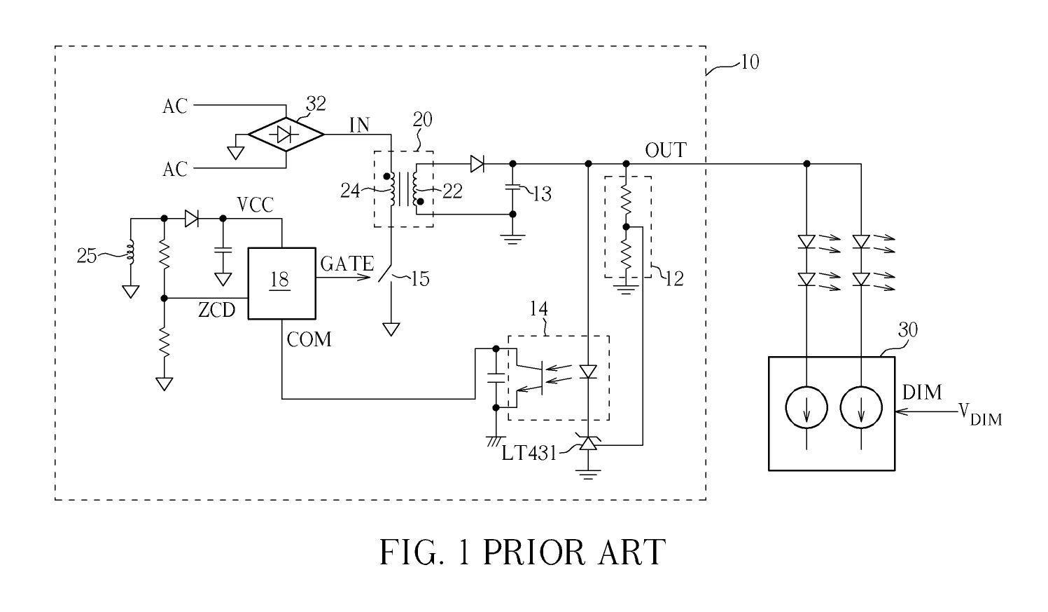

FIG. 2 is a diagram illustrating a control circuit of light emitting diodes according an embodiment.

FIG. 3 is a timing diagram illustrating signals in FIG. 2.

FIG. 4 is a diagram illustrating the toggling value of the target voltage according to another embodiment.

FIG. 5 is a diagram illustrating the toggling value of the target voltage according to another embodiment.

### DETAILED DESCRIPTION

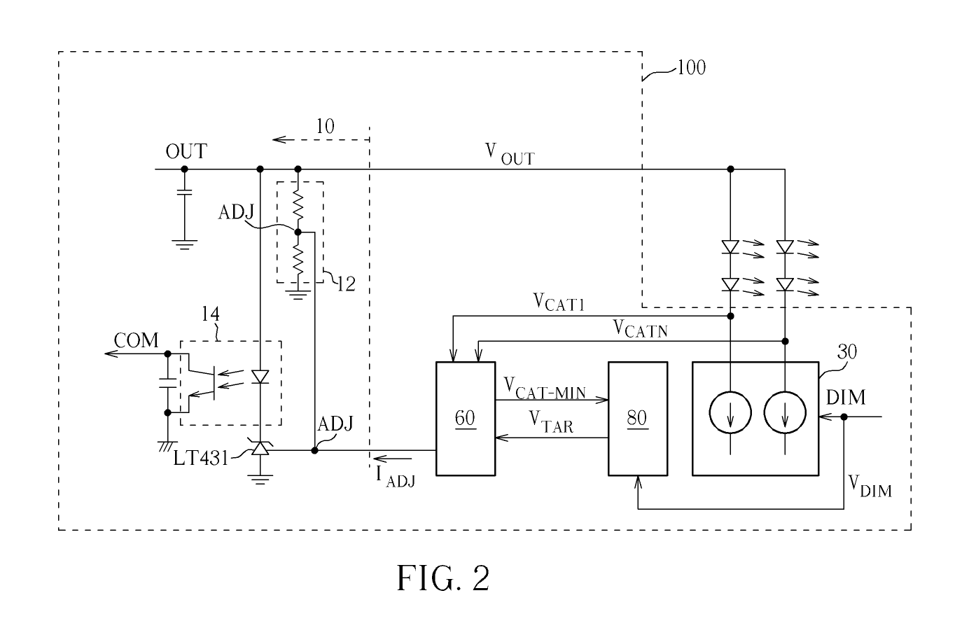

Please refer to FIG. 2. FIG. 2 is a diagram illustrating a control circuit 100 of light emitting diodes according an embodiment. The control circuit 100 includes a quasi-resonant power circuit 10, a smallest voltage feedback circuit 60, a target voltage adjuster 80, and a current balancing circuit 30. The quasi-resonant power circuit 10, the smallest voltage feedback circuit 60, and the current balancing circuit 30 can act together as a driver for providing an output power to drive a plurality of series of light emitting diodes for forcing a smallest terminal voltage V_{CAT-MIN} on the terminals of the plurality of series of light emitting diodes V_{CAT1} to V_{CATN} to approach a target voltage V_{TAR} or stabilize at the target voltage V_{TAR}. The target voltage adjuster 80 maintains or changes the target voltage V_{TAR} according to a dimming signal VDIM and the smallest terminal voltage V_{CAT-MIN}.

As those skilled in the prior art know, the quasi-resonant power circuit 10 can control a voltage of a node ADJ of a voltage divider 12 to approach a predetermined voltage (such as 2.5V defined by the LT431) . When the voltage of the node ADJ is fixed, an output voltage V_{OUT} can be determined.

The smallest voltage feedback circuit 60 detects the terminal voltages of the plurality of series of light emitting diodes V_{CAT1} to V_{CATN} to find the smallest terminal voltage V_{CAT-MIN}. The smallest voltage feedback circuit 60 can determine a value and a direction of an adjusting current I_{ADJ} according to the smallest terminal voltage V_{CAT-MIN}. For example, when the smallest terminal voltage V_{CAT-MIN} is lower than the target voltage V_{TAR}, the adjusting current I_{ADJ is} 0. Meanwhile, the output voltage V_{T} of the quasi-resonant power circuit 10 is increased to an output target of 80V (the output target of 80V is only an example), and the smallest terminal voltage V_{CAT-MIN} is pulled up simultaneously. If the smallest terminal voltage V_{CAT-MIN} is higher than the target voltage V_{TAR}, the adjusting current I_{ADJ} is a high adjusting current I_{ADJ-HIGH}, resulting in the voltage of the node ADJ being higher than 2.5V defined by the LT431. Meanwhile, in order to stabilize the voltage of the node ADJ at 2.5V, the output voltage V_{OUT} of the quasi-resonant power circuit 10 starts to be decreased to an output target of 40V (the output target of 40V is also only an example) and the smallest terminal voltage V_{CAT-MIN} is pulled down simultaneously. That is to say, the smallest voltage feedback circuit 60 works with the quasi-resonant power circuit 10 to force the smallest terminal voltage V_{CAT-MIN} to approach the target voltage V_{TAR} or stabilize at the target voltage V_{TAR}.

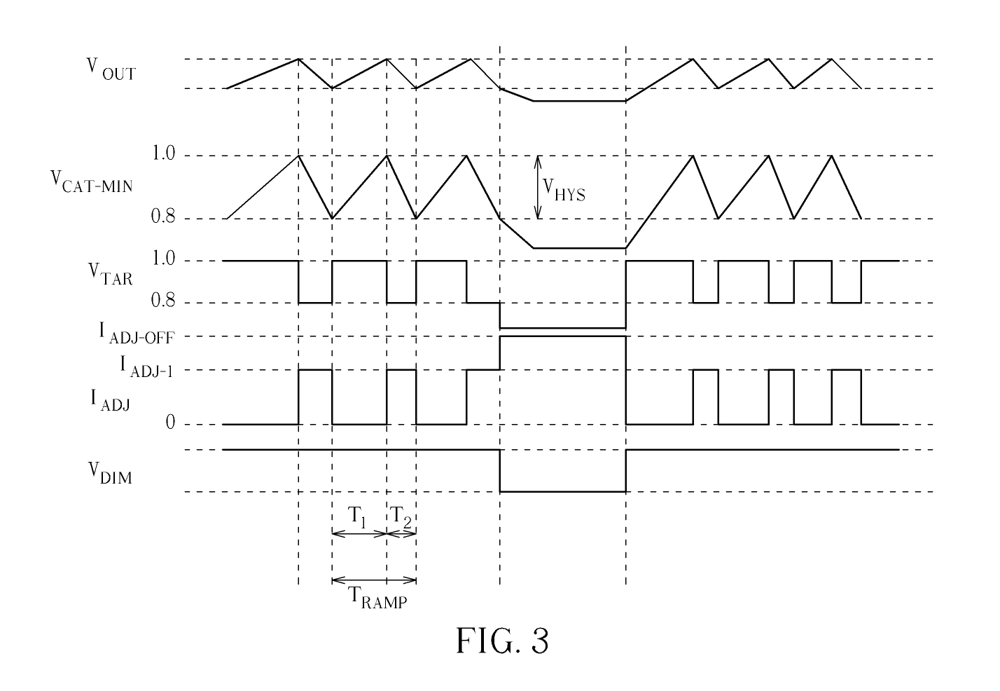

FIG. 3 is a timing diagram illustrating signals in FIG. 2, and FIG. 3 is used for explaining a control method of the target voltage adjuster 80. In FIG. 3, the signals from top to bottom are the output voltage V_{OUT}, the smallest terminal voltage V_{CAT- MIN}, the target voltage V_{TAR}, the adjusting current I_{ADJ}, and a dimming signal VDIM, respectively.

In FIG. 3, the dimming signal VDIM is a digital signal. When the dimming signal VDIM is at a logic-high voltage “1”, the current balancing circuit 30 sinks current. Meanwhile, the smallest terminal voltage V_{CAT-MIN} needs at least a predetermined value for current sources of the current balancing circuit 30 to have sufficient operation voltage. In FIG. 2, the smallest terminal voltage V_{CAT-MIN} is 0.8V. When the dimming signal VDIM is at a logic-low voltage “0”, the current balancing circuit 30 stops sinking current, so the smallest terminal voltage V_{CAT-MIN} can be decreased (the smallest terminal voltage V_{CAT-MIN} can be even lower than 0.8V) to save power.

In FIG. 3, when the dimming signal VDIM is at the logic-high voltage “1”, the target voltage V_{TAR} toggles between 1V and 0.8V. When the smallest terminal voltage V_{CAT-MIN} is lower than the target voltage V_{TAR}, the target voltage adjuster 80 forces the target voltage V_{TAR} to 1V. Meanwhile, because the adjusting current I_{ADJ} is 0 and the output voltage V_{OUT} is increased, the adjusting current I_{ADJ} and the output voltage V_{OUT} together boost the smallest terminal voltage V_{CAT-MIN} to approach 1V. When the smallest terminal voltage V_{CAT-MIN} is higher than 1V, the target voltage adjuster 80 forces the target voltage V_{TAR} to 0.8V. Meanwhile, because the adjusting current I_{ADJ} is a high value I_{ADJ-1} and the output voltage V_{OUT} is decreased, the adjusting current I_{ADJ} and the output voltage V_{OUT} together force the smallest terminal voltage _{V}_{CAT-MIN} to approach 0.8V. That is to say, hysteresis range V_{HYS} of the target voltage V_{TAR} is 0.2V (1.0V-0.8V).

In FIG. 3, when the dimming signal VDIM is at the logic-low voltage “0”, the target voltage V_{TAR} is lower than 0.8V, and can even go to 0V. Meanwhile, the adjusting current I_{ADJ} is the high value I_{ADJ-1} or a higher value I_{ADJ-OFF}. Because the target voltage V_{TAR} is decreased, the output voltage V_{OUT} is decreased gradually.

As shown in FIG. 3, an interval for the smallest terminal voltage V_{CAT-MIN} being gradually increased to 1.0V is defined as rising time T₁, an interval for the smallest terminal voltage V_{CAT-MIN} being gradually decreased to 0.8V is defined as falling time T₂, and an interval for the smallest terminal voltage V_{CAT-MIN} rising and falling once between 1.0V and 0.8V is defined as round-trip time T_{RAMP}. In FIG. 2, as long as a toggling value of the target voltage V_{TAR} is chosen properly, the round-trip time T_{RAMP} can be controlled properly, resulting in noise not generated by the round-trip time T_{RAMP} easily. For example, if the round-trip time T_{RAMP} is limited to not being lower than 16 ms (that is, a frequency corresponding to 16 ms is lower than 60 Hz which is the minimum of range of human hearing), noise can not be heard by humans easily.

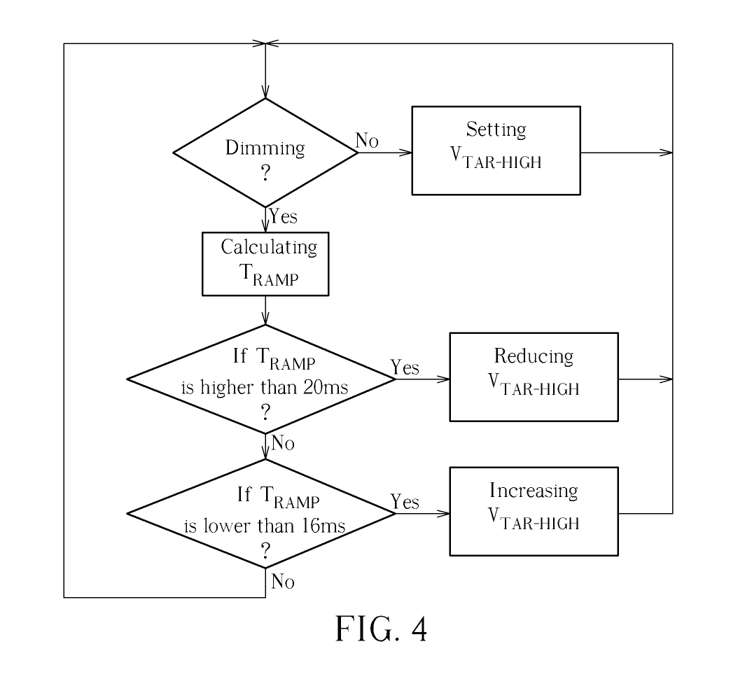

When the dimming signal VDIM is at the logic-high voltage “1”, the smallest terminal voltage V_{CAT-MIN} is toggled with the target voltage V_{TAR} to approach a high target voltage V_{TAR-HIGH} or a low target voltage V_{TAR-LOW}. In FIG. 3, the high target voltage V_{TAR-HIGH} (1.0V) , the low target voltage V_{TAR-LOW} (0.8V), and the hysteresis range V_{HYS} (0.2V) are fixed. But, in another embodiment, the high target voltage V_{TAR-HIGH}, the low target voltage V_{TAR-LOW}, and the hysteresis range V_{HYS} can be changed according to a practical condition. Please refer to FIG. 4. FIG. 4 is a diagram illustrating the toggling value of the target voltage V_{TAR} according to another embodiment. In FIG. 4, if the round-trip time T_{RAMP} is higher than 20 ms, the target voltage V_{TAR-HIGH} is reduced to reduce the round-trip time T_{RAMP}; if the round-trip time T_{RAMP} is lower than 16 ms the target voltage V_{TAR-HIGH} is increased to increase the round-trip time T_{RAMP}. Thus, the round-trip time T_{RAMP} is between 16 ms and 20 ms. In another embodiment, the target voltage V_{TAR-LOW} can be increased or decreased to limit the round-trip time T_{RAMP}.

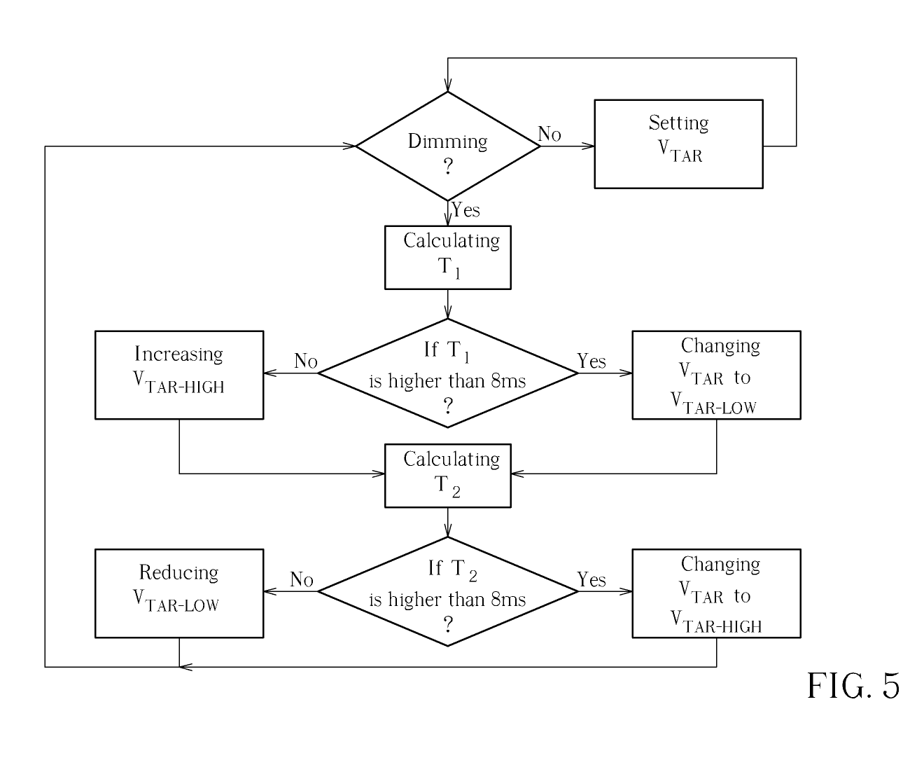

As shown in FIG. 3 and FIG. 4, the target voltage V_{TAR} is not changed until the smallest terminal voltage V_{CAT-MIN} reaches the target voltage V_{TAR.} However, in the embodiment in FIG. 5, the target voltage V_{TAR} can be changed when the smallest terminal voltage V_{CAT-MIN} has not yet reached the target voltage V_{TAR}. In FIG. 5, when the smallest terminal voltage V_{CAT-MIN} is increased to the high target voltage V_{TAR-HIGH} the rising time T₁ is increased gradually. If the rising time T₁ is greater than 8 ms and the target voltage V_{TAR} is not yet changed to the low target voltage V_{TAR-LOW}, the target voltage V_{TAR} is directly changed to the low target voltage V_{TAR-LOW}; if the rising time T₁ is lower than 8 ms and the target voltage V_{TAR} is changed to the low target voltage V_{TAR-LOW} the high target voltage V_{TAR-HIGH} is increased. Thus, the rising time T₁ is limited to about 8 ms. Similarly, if the falling time T₂ is greater than 8 ms and the target voltage V_{TAR} is not yet changed to the high target voltage V_{TAR-HIGH} the target voltage V_{TAR} is directly changed to the high target voltage V_{TAR-HIGH}; if the falling time T₂ is lower than 8 ms and the target voltage V_{TAR} is changed to the high target voltage V_{TAR-HIGH} the low target voltage V_{TAR-LOW} is decreased. Thus, the round-trip time T_{RAMP} is limited to about 16 ms.

Although the above embodiments take the quasi-resonant power circuit 10 as the first stage circuit, the above embodiments can also take other power circuits (such as an LLC power circuit) as the first stage circuit.

To sum up, the above embodiments of the present invention limit noise caused by the round-trip time T_{RAMP} to 60 Hz or lower than 60 Hz, which is out of the range of human hearing, by the abovementioned mechanisms through adjusting the target voltage V_{TAR}.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control circuit of light emitting diodes, the control circuit comprising:
a driver for providing an output power to drive at least one series of light emitting diodes, and forcing a smallest terminal voltage on the terminals of the at least one series of light emitting diodes to approach a target voltage; and
a target voltage adjuster for adjusting the target voltage according to the smallest terminal voltage.

2. The control circuit of claim 1, wherein the target voltage adjuster adjusts the target voltage to a higher value when the smallest terminal voltage is lower than the target voltage; and wherein the target voltage adjuster adjusts the target voltage to a lower value when the smallest terminal voltage is higher than the target voltage.

3. The control circuit of claim 2, wherein the target voltage adjuster changes the higher value or the lower value if a round-trip time when the smallest terminal voltage rises and falls once between the higher value and the lower value matches a predetermined condition.

4. The control circuit of claim 1, wherein the target voltage adjuster adjusts the target voltage to the higher value if a falling time when the smallest terminal voltage approaches the lower value is over a first predetermined value; and the target voltage adjuster adjusts the target voltage to the lower value if a rising time when the smallest terminal voltage to approach the higher value is over a second predetermined value.

5. The control circuit of claim 1, wherein the driver comprises:
a voltage regulator for controlling an output voltage of the output power, approaching the output voltage to an output target;
wherein the target voltage adjuster adjusts the output target according to the smallest terminal voltage.

6. A control circuit of light emitting diodes for driving at least one series of light emitting diodes coupled to an output power, the control circuit comprising:
a smallest voltage feedback circuit for generating an adjusting signal according to a smallest terminal voltage of the at least one series of light emitting diodes and a target voltage, wherein the adjusting signal influences the output power and forces the smallest terminal voltage to approach the target voltage; and
a target voltage adjuster for adjusting the target voltage according to the smallest terminal voltage.

7. The control circuit of claim 6, further comprising:
a driver for providing the output power to drive the at least one series of light emitting diodes, and forcing the smallest terminal voltage on the terminals of the at least one series of light emitting diodes to approach the target voltage according to the adjusting signal.

8. The control circuit of claim 6, wherein the target voltage adjuster adjusts the target voltage to a higher value when the smallest terminal voltage is lower than the target voltage; and wherein the target voltage adjuster adjusts the target voltage to a lower value when the smallest terminal voltage is higher than the target voltage.

9. The control circuit of claim 6, wherein the target voltage adjuster changes the higher value or the lower value if a round-trip time when the smallest terminal voltage rises and falls once between the higher value and the lower value matches a predetermined condition.

10. The control circuit of claim 6, wherein the target voltage adjuster adjusts the target voltage to the higher value if a falling time when the smallest terminal voltage approaches the lower value is over a first predetermined value; and the target voltage adjuster adjusts the target voltage to the lower value if a rising time when the smallest terminal voltage to approach the higher value is over a second predetermined value.

11. The control circuit of claim 6, wherein the control circuit comprises:
a voltage regulator for controlling an output voltage of the output power, and approaching the output voltage to an output target;
wherein the target voltage adjuster adjusts the output target according to the smallest terminal voltage.
